(19) United States
(12) Patent Application Publication
(10) Pub. No.: US 2018/0351331 A1
(43) Pub. Date: Dec. 6, 2018

(54) SPARK PLUG

(71) Applicant: NGK SPARK PLUG CO., LTD., Nagoya-shi, Aichi (JP)

(72) Inventors: Yukinobu HASEGAWA, Nagoya-shi, Aichi (JP); Yasushi SAKAKURA, Ichinomiya-shi, Aichi (JP)

(73) Assignee: NGK SPARK PLUG CO., LTD., Nagoya-shi, Aichi (JP)

(21) Appl. No.: 15/780,484

(22) PCT Filed: Sep. 13, 2016
(86) PCT No.: PCT/JP2016/004152

§ 371 Date: May 31, 2018

(30) Foreign Application Priority Data
Dec. 3, 2015 (JP) 2015-236307

(51) Int. Cl. H01T 13/32

(52) U.S. Cl. CPC H01T 13/32; H01T 13/39

(57) ABSTRACT

A spark plug includes a center electrode, an electrode tip having a discharge surface, and an opposite surface having a diameter greater than that of the discharge surface and located opposite the discharge surface, a tip holding element having a through hole, a ground electrode body having a recess, and a fusion portion formed at at least a portion of the boundary between the outer side surface of the tip holding element and the inner side surface of the recess.

### FIELD OF THE INVENTION

The present invention relates to a spark plug for igniting fuel gas in an internal combustion engine.

### BACKGROUND OF THE INVENTION

Conventionally, a spark plug is used in an internal combustion engine. The spark plug has a ground electrode for forming a gap. An electrode having an electrode tip formed of a noble metal, for example, is used as the ground electrode. Japanese Patent No. 4705129 discloses a technique in which an electrode tip is welded to a tip holding element while the tip holding element is welded to the ground electrode.

However, the above-mentioned technique cannot be said to exercise sufficient ingenuity with respect to welding between the ground electrode and the tip holding element and welding between the electrode tip and the tip holding element. Thus, upon exposure of the ground electrode and its periphery of the spark plug to a high-temperature environment in the course of use of the spark plug, there has been involved potential failure to sufficiently restrain the occurrence of cracking in the weld zones. As a result, for example, in the course of use in a high-temperature environment, there has been involved a potential occurrence of lifting or detachment of the electrode tip.

The present specification discloses a technique for restraining the occurrence of lifting or detachment of the electrode tip of the spark plug using the tip holding element for fixing the electrode tip to the ground electrode, in the course of use in a high-temperature environment.

### SUMMARY OF THE INVENTION

The technique disclosed in the present specification can be embodied in the following application examples.

### Application Example 1

In accordance with a first aspect of the present invention, there is provided a spark plug comprising

a center electrode,

an electrode tip having a discharge surface forming a gap in cooperation with the center electrode, and an opposite surface located opposite the discharge surface and having a diameter greater than that of the discharge surface,

a tip holding element which has a through hole and in which a portion of the electrode tip is disposed,

a ground electrode body having one end as a connection end connected to a metallic shell and the other end as a free end, and having a recess in which the tip holding element and at least a portion including the opposite surface of the electrode tip are disposed, and

a fusion portion formed at at least a portion of a boundary between an outer side surface of the tip holding element and an inner side surface of the recess,

when a direction directed from the opposite surface to the discharge surface is taken as a first direction, a diameter of the through hole at an end oriented in the first direction being equal to or greater than a diameter of the discharge surface and being smaller than a diameter of the opposite surface, and

the electrode tip being held by a bottom surface of the recess and by an inner surface of the tip holding element which defines the through hole,

the spark plug being characterized in that:

when, on a surface facing the first direction of the ground electrode body, an imaginary line extending from an axial line of the electrode tip toward the free end is taken as a first line, whereas an imaginary line extending from the axial line of the electrode tip toward the connection end is taken as a second line,

on the surface facing the first direction of the ground electrode body, a distance from a center of a first portion of the fusion portion, which portion intersects the first line, to a center of the electrode tip is longer than a distance from a center of a second portion of the fusion portion, which portion intersects the second line, to the center of the electrode tip; and

in a section which contains the first line and the axial line of the electrode tip,

a length along the first direction of the fusion portion at the first portion is longer than a length along the first direction of the recess at the first portion,

a length along the first direction of the fusion portion at the second portion is longer than a length along the first direction of the recess at the second portion,

at the first portion, the fusion portion does not reach the electrode tip, and

at the second portion, the fusion portion reaches the electrode tip.

Even when the fusion portion reaches the electrode tip on the side toward the free end of the ground electrode, heat transfer cannot be expected, because a portion of the ground electrode on the free end side is apt to have high temperature and has a free end. Also, in the case where the fusion portion reaches the electrode tip on the side toward the free end of the ground electrode, since the portion of the ground electrode on the free end side is apt to have high temperature, the fusion portion is apt to suffer the occurrence of cracking caused by thermal stress stemming from the difference in thermal expansion coefficient between the electrode tip and the tip holding element. By contrast, on the side toward the connection end of the ground electrode, when the fusion portion reaches the electrode tip, heat transfer is improved. Also, a portion of the ground electrode on the connection end side is unlikely to have high temperature as compared with the portion on the free end side. Therefore, on the side toward the connection end, even when the fusion portion reaches the electrode tip, the fusion portion is unlikely to suffer the occurrence of cracking caused by thermal stress. According to the above configuration, since the length along the first direction of the fusion portion is longer than the length along the first direction of the recess at the first portion on the free end side and at the second portion on the connection end side, the electrode tip can be held with sufficient strength. Further, since the fusion portion does not reach the electrode tip at the first portion, whereas the fusion portion reaches the electrode tip at the second portion, the occurrence of cracking in the fusion portion can be restrained while heat transfer is improved. Therefore, in the course of use in a high-temperature environment, the occurrence of lifting or detachment of the electrode tip can be restrained.

### Application Example 2

In accordance with a second aspect of the present invention, there is provided a spark plug according to application example 1, wherein the fusion portion is formed along the entire circumference of a boundary between the outer side surface of the tip holding element and the inner side surface of the recess.

Through employment of such a welding feature, since strength of holding the electrode tip is improved, in the course of use in a high-temperature environment, the occurrence of lifting or detachment of the electrode tip can be more effectively restrained.

### Application Example 3

In accordance with a third aspect of the present invention, there is provided a spark plug according to application example 1 or 2, wherein

the electrode tip has a tip body including the discharge surface, and a collar portion including the opposite surface, having a diameter greater than that of the tip body, and located on a side of the tip body opposite the first direction, and

at the second portion, the fusion portion reaches the collar portion of the electrode tip.

Through employment of such a structural feature, since the electrode tip has the collar portion, the electrode tip can be reliably held to the ground electrode body. Also, at the second portion, the fusion portion can reliably reach the electrode tip. As a result, in the course of use in a high-temperature environment, the occurrence of lifting or detachment of the electrode tip can be more effectively restrained.

The present invention can be implemented in various forms; for example, a spark plug, an ignition device using the spark plug, an internal combustion engine having the spark plug, and an internal combustion engine having the ignition device using the spark plug.

### BRIEF DESCRIPTION OF THE DRAWINGS

FIG. 1 is a sectional view showing an example of a spark plug according to a first embodiment.

FIG. 2 is a fragmentary sectional view showing, on an enlarged scale, a distal end portion and its periphery of a ground electrode according to the first embodiment.

FIG. 3 is a schematic view showing the distal end portion and its periphery of the ground electrode as viewed in a forward direction from a rear side.

FIG. 4 is an exploded view showing the distal end portion of the ground electrode according to the first embodiment as viewed before laser welding.

FIG. 5 is a flowchart showing an example of a method of manufacturing the spark plug.

FIG. 6 is a view showing a state in which an electrode tip and a tip holding element are disposed in a recess.

FIG. 7 is a fragmentary sectional view showing, on an enlarged scale, a distal end portion and its periphery of a ground electrode according to a second embodiment.

FIG. 8 is an exploded view showing the distal end portion of the ground electrode according to the second embodiment as viewed before laser welding.

FIG. 9 is an explanatory view showing a ground electrode according to a modified embodiment.

### DETAILED DESCRIPTION OF THE INVENTION

### A. First Embodiment

### A-1. Configuration of Spark Plug:

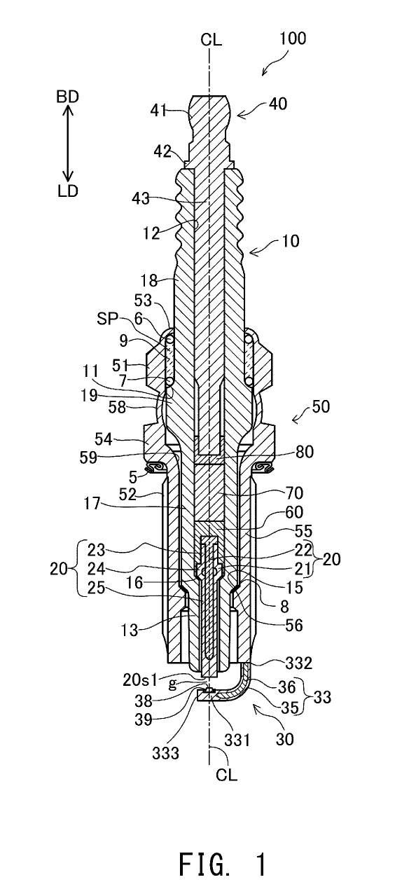

FIG. 1 is a sectional view showing an example of a spark plug according to a first embodiment. The illustrated line CL indicates an axial line CL of a spark plug 100. The illustrated section is a section which contains the axial line CL. Hereinafter, a direction in parallel with the axial line CL may also be called an “axial direction.” Of the direction in parallel with the axial line CL, the downward direction in FIG. 1 may also be called a forward direction LD, and the upward direction in FIG. 1 may also be called a rearward direction BD. The forward direction LD is directed from a metal terminal member 40 toward electrodes 20 and 30, these members being described later. A radial direction of a circle centered on the center axis may be called merely a “radial direction,” and a circumferential direction of the circle centered on the center axis may be called merely a “circumferential direction.” An end of the forward direction LD may be called merely a forward end, and an end of the rearward direction BD may be called merely a rear end.

The spark plug 100 includes an insulator 10, the center electrode 20, the ground electrode 30, the metal terminal member 40, a metallic shell 50, an electrically conductive first seal member 60, a resistor 70, an electrically conductive second seal member 80, a first packing 8, talc 9, a second packing 6, and a third packing 7.

The insulator 10 is an approximately cylindrical member having an axial hole 12, which is a through hole extending through the insulator 10 along the axial line CL. The insulator 10 is formed by firing alumina (other insulating materials can also be employed). The insulator 10 has a leg portion 13, a first outside-diameter-reducing portion 15, a first trunk portion 17, a collar portion 19, a second outside-diameter-reducing portion 11, and a second trunk portion 18 in order of disposition in the rearward direction BD from a forward direction LD side (hereinafter, may be called merely a forward side). The outside diameter of the first outside-diameter-reducing portion 15 reduces gradually in the forward direction LD from a rearward direction BD side (hereinafter, may be called merely a rear side). An inside-diameter-reducing portion 16 whose inside diameter reduces gradually in the forward direction LD from the rear side is formed in the vicinity (in the example of FIG. 1, the first trunk portion 17) of the first outside-diameter-reducing portion 15 of the insulator 10. The outside diameter of the second outside-diameter-reducing portion 11 reduces gradually in the rearward direction BD from the forward side.

The rodlike center electrode 20 extending along the axial line CL is inserted into a forward portion of the axial hole 12 of the insulator 10. The center electrode 20 has a leg portion 25, a collar portion 24, and a head portion 23 in order of disposition in the rearward direction BD from the forward side. A forward end portion of the leg portion 25 protrudes outward from the axial hole 12 on the forward side of the insulator 10. The remaining portion of the center electrode 20 is disposed within the axial hole 12. The forward end surface of the collar portion 24 is supported by the inside-diameter-reducing portion 16 of the insulator 10. The center electrode 20 has an electrode base metal 21 and a core metal 22 embedded in the electrode base metal 21. The electrode base metal 21 is formed by use of, for example, nickel (Ni) or an alloy (e.g., INCONEL (registered trademark)) which contains nickel as a main component. The term “main component” means a component whose content is the highest. Weight percent is employed as a unit of content. The core metal 22 is formed by use of a material (e.g., an alloy which contains copper) higher in thermal conductivity than the electrode base metal 21.

The metal terminal member 40 is inserted into a rear portion of the axial hole 12 of the insulator 10. The metal terminal member 40 is formed by use of an electrically conductive material (e.g., low-carbon steel or a like metal). The metal terminal member 40 has a cap attachment portion 41, a collar portion 42, and a leg portion 43 in order of disposition in the forward direction LD from the rear side. The cap attachment portion 41 protrudes rearward from the axial hole 12 of the insulator 10. The leg portion 43 is inserted into the axial hole 12 of the insulator 10.

In the axial hole 12 of the insulator 10, the circular columnar resistor 70 is disposed between the metal terminal member 40 and the center electrode 20 for suppressing electrical noise. The electrically conductive first seal member 60 is disposed between the resistor 70 and the center electrode 20, and the electrically conductive second seal member 80 is disposed between the resistor 70 and the metal terminal member 40. The center electrode 20 and the metal terminal member 40 are electrically connected via the resistor 70 and the seal members 60 and 80. As a result of use of the seal members 60 and 80, contact resistance between the stacked members 20, 60, 70, 80, and 40 is stabilized, whereby electric resistance between the center electrode 20 and the metal terminal member 40 can be stabilized. The resistor 70 is formed by use of, for example, glass particles (e.g., B₂O₃—SiO₂ glass) as a main component, ceramic particles (e.g., TiO₂), and an electrically conductive material (e.g., Mg). The seal members 60 and 80 are formed by use of, for example, glass particles similar to the case of the resistor 70, and metal particles (e.g., Cu).

The metallic shell 50 is an approximately cylindrical member having a through hole 59 extending therethrough along the axial line CL. The metallic shell 50 is formed by use of low-carbon steel (other electrically conductive materials (e.g., metal materials) can also be employed). The insulator 10 is inserted into the through hole 59 of the metallic shell 50. The metallic shell 50 is fixed to the insulator 10 while being disposed radially around the insulator 10. A forward end portion of the insulator 10 (in the present embodiment, a forward end portion of the leg portion 13) protrudes outward from the forward end of the through hole 59 of the metallic shell 50. A rear portion of the insulator 10 (in the present embodiment, a rear portion of the second trunk portion 18) protrudes outward from the rear end of the through hole 59 of the metallic shell 50.

The metallic shell 50 has a trunk portion 55, a seat portion 54, a deformed portion 58, a tool engagement portion 51, and a crimp portion 53 in order of disposition in the rearward direction BD from the forward side. The seat portion 54 is a collar portion. The trunk portion 55 has a threaded portion 52 formed on its outer circumferential surface for threading engagement with a mounting hole of an internal combustion engine (e.g., a gasoline engine). An annular gasket 5 formed by bending a metal sheet is fitted between the seat portion 54 and the threaded portion 52.

The metallic shell 50 has an inside-diameter-reducing portion 56 disposed forward of the deformed portion 58. The inside diameter of the inside-diameter-reducing portion 56 reduces gradually in the forward direction LD from the rear side. The first packing 8 is held between the inside-diameter-reducing portion 56 of the metallic shell 50 and the first outside-diameter-reducing portion 15 of the insulator 10. The first packing 8 is an O-ring made of iron (other materials (e.g., copper and a like metal material) can also be employed).

The tool engagement portion 51 has a shape (e.g., hexagonal prism) to be engaged with a spark plug wrench. The crimp portion 53 is provided on the rear side of the tool engagement portion 51. The crimp portion 53 is disposed rearward of the second outside-diameter-reducing portion 11 of the insulator 10 and forms the rear end of the metallic shell 50. The crimp portion 53 is bent radially inward.

At a rear end portion of the metallic shell 50, an annular space SP is formed between an inner circumferential surface of the metallic shell 50 and an outer circumferential surface of the insulator 10. In the present embodiment, the space SP is surrounded by the crimp portion 53 and the tool engagement portion 51 of the metallic shell 50 and by the second outside-diameter-reducing portion 11 and the second trunk portion 18 of the insulator 10. The second packing 6 is disposed in a rear end portion of the space SP. The third packing 7 is disposed in a forward end portion of the space SP. In the present embodiment, the two packings 6 and 7 in the space SP are C-rings made of iron (other materials can also be employed). Powder of the talc 9 is charged into the space SP between the two packings 6 and 7.

In manufacture of the spark plug 100, the crimp portion 53 is crimped in such a manner as to be bent inward. Thus, the crimp portion 53 is pressed forward. As a result, the deformed portion 58 is formed through deformation, and the insulator 10 is pressed forward via the packings 6 and 7 and the talc 9 within the metallic shell 50. The first packing 8 is pressed between the first outside-diameter-reducing portion 15 and the inside-diameter-reducing portion 56, thereby providing a seal between the metallic shell 50 and the insulator 10. As a result of the above operations, there can be restrained outward leakage of gas in a combustion chamber of an internal combustion engine through a gap between the metallic shell 50 and the insulator 10. Also, the metallic shell 50 is fixed to the insulator 10.

The ground electrode 30 is joined to the forward end of the metallic shell 50. The ground electrode 30 has an electrode body 33, an electrode tip 38, and a tip holding member 39. In the present embodiment, the electrode body 33 is a rodlike member. One end of the electrode body 33 is a connection end 332 connected to the forward end of the metallic shell 50 by, for example, resistance welding for establishing electrical conduction. The other end of the electrode body 33 is a free end 333. The electrode body 33 extends in the forward direction LD from the connection end 332 connected to the metallic shell 50 and is then bent toward the axial line CL. Then, the electrode body 33 extends in a direction perpendicular to the axial line CL and reaches the free end 333. A portion of the electrode body 33 extending in the direction perpendicular to the axial line CL is also called a distal end portion 331. The electrode tip 38 and the tip holding element 39 are fixed to a rear surface of the distal end portion 331. The electrode tip 38 forms a gap g in cooperation with a forward end surface 20s1 (surface of the forward end) of the center electrode 20. The electrode body 33 has a base metal 35 which forms a surface region of the electrode body 33, and a core metal 36 embedded in the base metal 35. The base metal 35 is formed by use of, for example, Ni or an alloy (e.g., INCONEL) which contains Ni as a main component. The core metal 36 is formed by use of a material (e.g., pure copper) higher in thermal conductivity than the base metal 35.

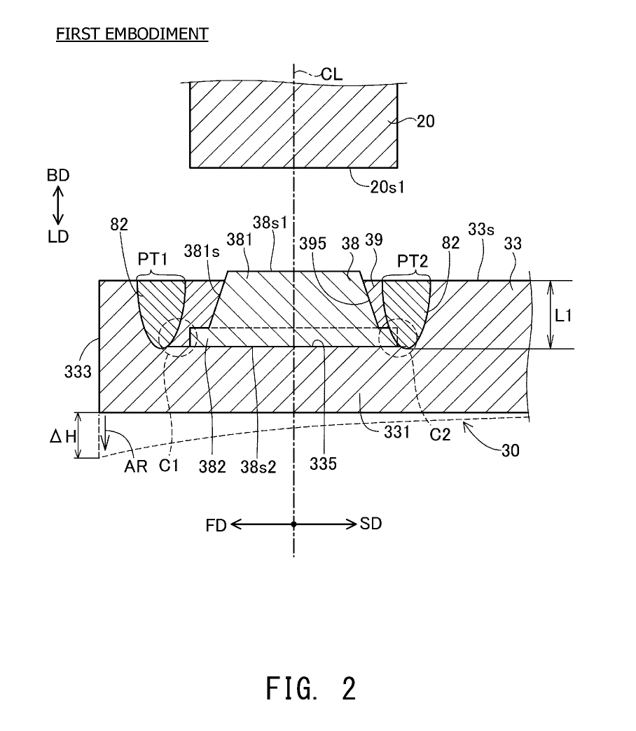

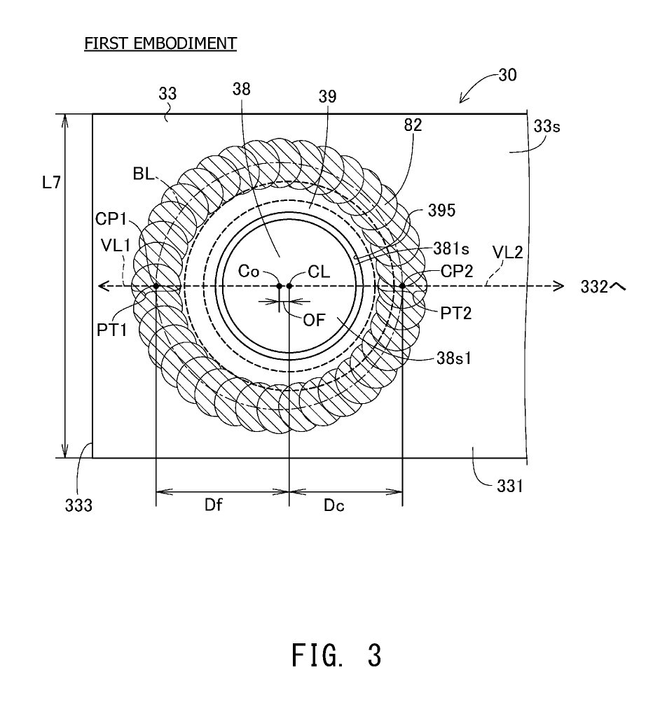

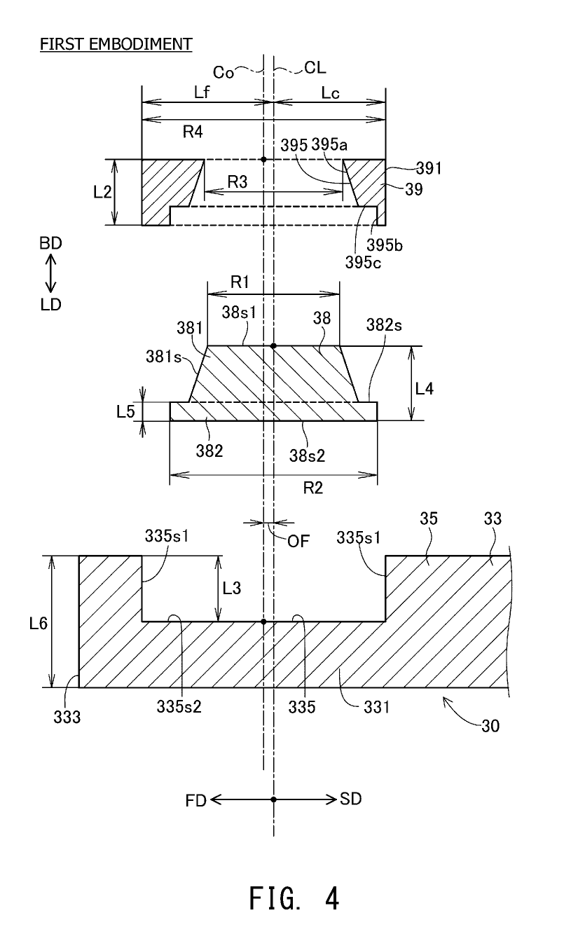

FIG. 2 is a fragmentary sectional view showing, on an enlarged scale, the distal end portion 331 and its periphery of the ground electrode 30 according to the first embodiment. FIG. 3 is a schematic view showing the distal end portion 331 and its periphery of the ground electrode 30 as viewed in the forward direction LD from the rear side. FIG. 4 is an exploded view showing the distal end portion 331 of the ground electrode 30 according to the first embodiment as viewed before laser welding. As shown in FIG. 2, the above-mentioned distal end portion 331 extends in a direction perpendicular to the axial line CL. A direction perpendicular to the axial line CL and directed toward the free end 333 from the axial line CL is called a free-end direction FD. A direction perpendicular to the axial line CL and opposite the free-end direction FD; i.e., a direction directed toward the connection end 332 from the axial line CL, is called a connection-end direction CD.

As shown in FIGS. 2 and 4, the electrode tip 38 has a discharge surface 38s1 on the rear side and an opposite surface 38s2 opposite the discharge surface 38s1 (i.e., on the forward side). The discharge surface 38s1 forms the gap g in cooperation with the forward end surface 20s1 of the center electrode 20. The electrode tip 38 has a tip body 381 including the discharge surface 38s1, and a collar portion 382 including the opposite surface 38s2 and located forward of the tip body 381. The outside diameter of the tip body 381 reduces linearly toward the center electrode 20; i.e., toward the rear side from the forward side. That is, the tip body 381 has the shape of a truncated cone having a so-called tapered outer side surface 381s. The outside diameter of the collar portion 382 is greater than the diameters of the forward and rear ends of the tip body 381. The axial line CL of the electrode tip coincides with the axial line CL of the spark plug 100. As is understood from this description, diameter R2 (FIG. 4) of the opposite surface 38s2 is greater than diameter R1 (FIG. 4) of the discharge surface 38s1.

The electrode tip 38 is formed by use of an alloy which contains, as a main component, a noble metal exhibiting excellent resistance to spark-induced erosion. In the present embodiment, the noble metal contained as a main component is iridium. Among noble metals, Ir is high in melting point and exhibits excellent resistance to spark-induced erosion. Therefore, preferably, the electrode tip 38 is formed by use of Ir or an alloy which contains Ir as a main component.

As shown in FIG. 4, the tip holding element 39 has a cylindrical external form. The tip holding element 39 has a through hole 395 formed therein. The axial line CL of the through hole 395 coincides with the axial line CL of the spark plug 100. The axial line CL of the through hole 395 and an axial line Co of the cylindrical external form of the tip holding element 39 are in parallel with each other. The axial line Co of the cylindrical external form of the tip holding element 39 is offset in the free-end direction FD in relation to the axial line CL of the through hole 395. Thus, as shown in FIG. 4, in a state before the tip holding member 39 is welded to the ground electrode 30, distance Lf (FIG. 4) between the axial line CL and a portion of an outer side surface 391 of the tip holding element 39 located on the free-end direction FD side as viewed from the axial line CL is longer than distance Lc between the axial line CL and a portion of the outer side surface 391 of the tip holding element 39 located on the connection-end direction CD side as viewed from the axial line CL.

The through hole 395 includes a rear-side hole 395a and a forward-side hole 395b located forward of the rear-side hole 395a and having a diameter greater than that of the rear-side hole 395a. The shape of the rear-side hole 395a corresponds to the shape of a forward-side portion of the tip body 381 of the electrode tip 38 and reduces in diameter linearly from the forward side toward the rear side. The shape of the forward-side hole 395b corresponds to the shape of the collar portion 382 of the electrode tip 38 and has a diameter approximately equal to the outside diameter of the collar portion 382. A step portion 395c is formed between the rear-side hole 395a and the forward-side hole 395b. Diameter R3 (FIG. 4) of the rear end of the through hole 395 is equal to or greater than diameter R1 (FIG. 4) of the discharge surface 38s1 and is smaller than diameter R2 of the opposite surface 38s2. As a result, as shown in FIG. 2, a portion including the opposite surface 38s2 of the electrode tip 38 (the entire collar portion 382 and a rear-side portion of the tip body 381) is fitted into the through hole 395. The step portion 395c is in contact with a rear-side surface 382s (FIG. 4) of the collar portion 382, thereby appropriately restraining the occurrence of lifting or detachment of the electrode tip 38.

As shown in FIGS. 2 and 4, the electrode body 33 has a recess 335 formed on its surface at a position facing the forward end surface 20s1 of the center electrode 20, and recessed in the forward direction LD. As shown in FIG. 4, before welding of the tip holding element 39, the recess 335 has an approximately cylindrical shape. The axial line Co of the approximately cylindrical shape of the recess 335 coincides with the axial line Co of the cylindrical external form of the tip holding element 39. The recess 335 is formed in the base metal 35 of the electrode body 33. The recess 335 before welding of the tip holding element 39 has an inner side surface 335s1 and a bottom surface 335s2. A forward-side portion (including the opposite surface 38s2) of the electrode tip 38, and the tip holding element 39 which surrounds the electrode tip 38 are disposed in the recess 335.

As shown in FIG. 3, a fusion portion 82 is formed along the entire circumference of the boundary between the outer side surface of the tip holding element 39 and the inner side surface of the recess 335. In FIG. 3, the hatched portion is a portion of the fusion portion 82 exposed from a rear end surface 33s of the electrode body 33. The fusion portion 82 is formed by radiating a laser beam in a direction perpendicular to the surface 33s. Length (depth) L1 (FIG. 2) in the axial direction of the fusion portion 82 is longer than length L2 in the axial direction of the tip holding element 39 along the entire circumference of the fusion portion 82. Also, length L1 (FIG. 2) in the axial direction of the fusion portion 82 is longer than length (depth) L3 in the axial direction of the recess 335 along the entire circumference of the fusion portion 82. Length L2 in the axial direction of the tip holding element 39 and length L3 in the axial direction of the recess 335 are approximately equal to each other.

As a result of the tip holding element 39 being laser-welded to the electrode body 33, the electrode tip 38 is held to the electrode body 33 by the inner surface of the tip holding element 39 which defines the through hole 395 and by the bottom surface 335s2 of the recess 335.

As shown in FIG. 3, on the surface 33s of the electrode body 33, an imaginary line extending in the free-end direction FD from the axial line CL of the electrode tip 38 is taken as a first line VL1, and an imaginary line extending in the connection-end direction CD from the axial line CL of the electrode tip 38 is taken as a second line VL2. On the surface 33s of the electrode body 33, a portion of the fusion portion 82 hatched in FIG. 3, which portion intersects the first line VL1, is taken as a first portion PT1, and a portion of the fusion portion 82, which portion intersects the second line VL2, is taken as a second portion PT2. Distance Df from a center CP1 of the first portion PT1 to the center (i.e., the axial line CL) of the electrode tip 38 is longer than distance Dc from a center CP2 of the second portion PT2 to the center of the electrode tip 38. This is because, as mentioned above, as a result of the axial line Co of the cylindrical external form of the tip holding element 39 being offset in the free-end direction FD in relation to the axial line CL of the through hole 395, as shown in FIG. 4, in a state before welding of the tip holding element 39, distance Lf between the axial line CL and a portion of the outer side surface 391 of the tip holding element 39 located on the free-end direction FD side as viewed from the axial line CL is longer than distance Lc between the axial line CL and a portion of the outer side surface 391 of the tip holding element 39 located on the connection-end direction CD side as viewed from the axial line CL.

FIG. 2 can be said to be a sectional view taken by cutting the ground electrode 30 and the center electrode 20 by a plane which contains the axial line CL of the electrode tip 38, the first line VL1, and the second line VL2. In this sectional view, the section of the first portion PT1 of the fusion portion 82 and the section of the second portion PT2 of the fusion portion 82 appear. As shown in FIG. 2, at the first portion PT1, the fusion portion 82 does not reach the electrode tip 38. That is, as indicated by circle C1, at the first portion PT1, the fusion portion 82 and the electrode tip 38 are separated from each other. Further, as shown in FIG. 2, at the second portion PT2, the fusion portion 82 reaches the electrode tip 38 (specifically, the collar portion 382 of the electrode tip 38). That is, as indicated by circle C2, at the second portion PT2, a portion of the collar portion 19 of the electrode tip 38 fuses as a result of laser welding and becomes a portion of the fusion portion 82. As a result, as indicated by circle C2, at the second portion PT2, the collar portion 382 of the electrode tip 38 and the fusion portion 82 are in contact with each other.

As mentioned above, length L1 (FIG. 2) in the axial direction of the fusion portion 82 is longer than length L3 in the axial direction of the recess 335 along the entire circumference of the fusion portion 82. Therefore, at both of the first portion PT1 and the second portion PT2, length L1 in the axial direction of the fusion portion 82 is longer than length L3 in the axial direction of the recess 335.

### A-2. Method of Manufacturing Spark Plug:

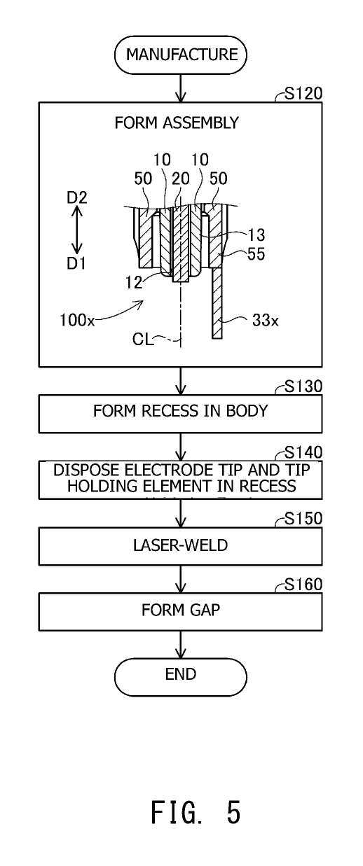

FIG. 5 is a flowchart showing an example of a method of manufacturing the spark plug. In step S120, an assembly is formed. The assembly is in a state before bending of the electrode body 33 of the ground electrode 30 and before attachment of the electrode tip 38 and the tip holding element 39 onto the electrode body 33 in the course of manufacture of the spark plug 100 shown in FIG. 1. The frame showing step S120 in FIG. 5 contains a fragmentary sectional view showing partially the center electrode 20 and its periphery of the assembly 100x. The assembly 100x has the insulator 10, the metallic shell 50 fixed to the insulator 10, and the center electrode 20 inserted into the axial hole 12 of the insulator 10. A straight electrode body 33x which is to become the electrode body 33 through subjection to bending is joined to the metallic shell 50. The drawing eliminates the illustration of the base metal 35 and the core metal 36 of the electrode body 33x. Other drawings to be mentioned later may also eliminate the illustration of the base metal 35 and the core metal 36. Publicly known various methods can be employed for forming the assembly, and detailed description thereof is omitted.

In step S130, the recess 335 is formed in the electrode body 33x of the ground electrode 30. The shape of the recess 335 has been described with reference to FIG. 4. The recess 335 is formed in the electrode body 33x which is to undergo bending, by use of, for example, a drill or a like cutting tool.

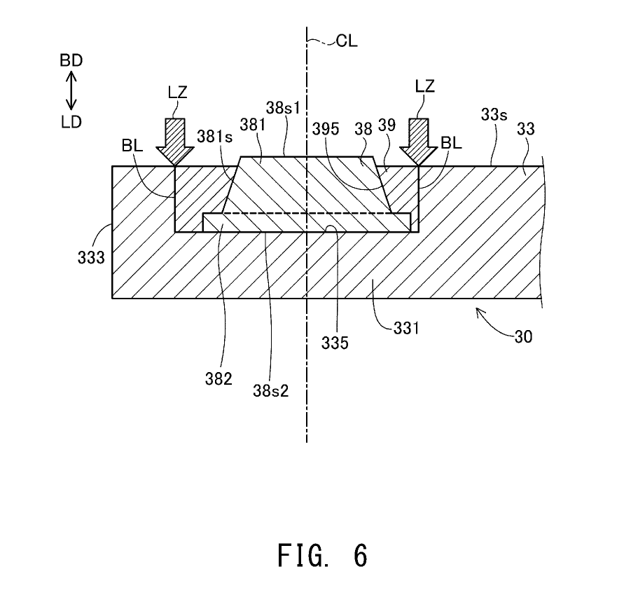

In step S140, the electrode tip 38 and the tip holding element 39 are disposed in the formed recess 335. FIG. 6 shows a state in which the electrode tip 38 and the tip holding element 39 are disposed in the recess 335. Specifically, the electrode tip 38 is disposed in the through hole 395 of the tip holding element 39. Then, the tip holding element 39 and the electrode tip 38 in such a state are fitted into the recess 335.

In step S150, the tip holding element 39 is laser-welded to the recess 335. The arrows LZ of FIG. 6 conceptually show radiation of a laser beam for laser welding. The laser beam LZ is radiated onto a boundary BL between the inner side surface 335s1 of the recess 335 and the outer side surface 391 of the tip holding element 39 perpendicularly to the surface 33s of the electrode body 33. The laser beam LZ is radiated along the entire circumference of the boundary BL between the inner side surface 335s1 of the recess 335 and the outer side surface 391 of the tip holding element 39. For example, the laser beam LZ is radiated at 24 positions at a speed of 12 Hz, whereby the fusion portion 82 is formed along the entire circumference of the boundary BL. As a result, the fusion portion 82 shown in FIGS. 2 and 3 is formed. The fusion portion 82 contains components of the electrode body 33 (base metal 35) and components of the tip holding element 39 as a result of mutual fusion. The electrode body 33 and the tip holding element 39 are joined via the fusion portion 82. Therefore, the fusion portion 82 can be said to be a joint for joining the electrode body 33 and the tip holding element 39, or a bead for joining the electrode body 33 and the tip holding element 39.

Even if the electrode body 33 and the tip holding element 39 are formed of the same material (e.g., INCONEL 600), the fusion portion 82 differs from the electrode body 33 and the tip holding element 39 in, for example, fine texture such as grain size, since the fusion portion 82 is formed as a result of high-temperature fusion. Thus, for example, by cutting the ground electrode 30 to expose the section of FIG. 2, etching the section, and observing the etched section, the boundary between the fusion portion 82 and the electrode body 33 or the tip holding element 39 can be clearly identified.

In step S160, the electrode body 33x is bent, thereby forming the gap g. Specifically, as shown in FIG. 2, the electrode body 33x is bent toward the center electrode 20 in such a manner that the forward end surface 20s1 of the center electrode 20 and the discharge surface 38s1 of the electrode tip 38 face each other.

### A-3. Evaluation Test:

An evaluation test was conducted by use of samples of the spark plug 100. In the evaluation test, as shown in Table 1, five types of samples of the spark plug 100; specifically, samples 1 to 5, were prepared. Dimensions common to the samples are as follows:

Outside diameter R1 of discharge surface 38s1 of electrode tip 38 (FIG. 4): 2.5 mm

Outside diameter R2 of opposite surface 38s2 of electrode tip 38 (FIG. 4): 2.8 mm

Length L4 in axial direction of electrode tip 38 (FIG. 4): 0.6 mm

Length L5 in axial direction of collar portion 382 (FIG. 4): 0.1 mm

Outside diameter R4 of tip holding element 39 (FIG. 4): 3.6 mm

Length L2 in axial direction of tip holding element 39 (FIG. 4): 0.4 mm

Length L6 in axial direction of electrode body 33 (FIG. 4): 1.5 mm

Width L7 of electrode body 33 (FIG. 3): 4.4 mm

Length L1 in axial direction of fusion portion 82 (FIG. 2): 0.5 mm

TABLE 1

| | | Tip | | | Appear- | |
|---|---|---|---|---|---|---|
| | Offset | joining | Thermal | Electrode | ance of | Compre- |
| Sample | OF | perform- | conduct- | deform- | fusion | hensive |
| No. | (mm) | ance | ivity | ation | portion | evaluation |
| 1 | 0 | C | B | C | A | C |
| 2 | 0.1 | A | A | A | A | A |
| 3 | 0.2 | A | A | A | B | A |
| 4 | 0.3 | A | A | A | B | A |
| 5 | 0.4 | A | A | A | C | C |

In five types of samples 1 to 5, an offset in the free-end direction FD of the axial line Co of the tip holding element 39 from the axial line CL of the electrode tip 38 is represented by OF (FIGS. 3 and 4). Five types of samples 1 to 5 differ in offset OF; specifically, samples 1 to 5 have offsets OF of 0, 0.1 mm, 0.2 mm, 0.3 mm, and 0.4 mm, respectively. Since sample 1 has an offset OF of 0, sample 1 is not a sample of the spark plug 100 of the embodiment, but is a comparative sample. In the samples, the electrode tips 38 were formed by use of an iridium alloy, and the electrode bodies 33 and the tip holding elements 39 were formed by use of a nickel alloy of INCONEL 600.

In comparative sample 1, at both of the first portion PT1 and the second portion PT2 mentioned above, the fusion portion 82 reaches the collar portion 382 of the electrode tip 38. In samples 2 to 5 of the spark plug 100 of the embodiment, at the first portion PT1, the fusion portion 82 does not reach the collar portion 382 of the electrode tip 38, whereas, at the second portion PT2, the fusion portion 82 reaches the collar portion 382 of the electrode tip 38.

First, samples 1 to 5 were evaluated for appearance of the fusion portion 82. A sample free from adhesion of the fusion portion 82 (so-called ascendance of fusion sagging) to the side surface of the electrode tip 38 was evaluated as “A;” a sample exhibiting slight adhesion to the side surface of the electrode tip 38 was evaluated as “B;” and a sample exhibiting apparent adhesion to the side surface of the electrode tip 38 was evaluated as “C.”

Further, samples 1 to 5 underwent a temperature cycle test. In the temperature cycle test, a cycle consisting of heating and cooling was repeated 1,000 times in the vicinity of the electrode tips 38 of the ground electrodes of the samples. In one cycle, heating to 950° C. to 100° C. was performed for two minutes by use of a high-frequency heater; subsequently, natural cooling in the air was performed for one minute.

Subsequently, the samples were evaluated for tip joining performance. Specifically, the samples were inspected for lifting or detachment of the electrode tips 38. The inspection was conducted visually and by comparing the traced external forms before and after the test of the electrode tip 38 as viewed from a direction perpendicular to the axial direction. A sample free from lifting and detachment of the electrode tip 38 was evaluated as “A,” and a sample exhibiting lifting or detachment of the electrode tip 38 was evaluated as “C.”

Further, the samples were evaluated for thermal conductivity. Specifically, in the temperature cycle test, temperature drop ΔT of the electrode tip 38 as a result of cooling for one minute after completion of heating for two minutes was measured by use of a thermocouple. A sample exhibiting an average drop ΔT of 100 degrees or more was evaluated as “A;” a sample exhibiting an average drop ΔT of 50 degrees to less than 100 degrees was evaluated as “B;” and a sample exhibiting an average drop ΔT of less than 50 degrees was evaluated as “C.”

Further, the samples were evaluated for deformation of the ground electrode 30. Specifically, after the test, the samples were measured for deformation ΔH indicative of deformation of the free end 333 of the electrode body 33 in the direction indicated by the arrow AR of FIG. 2 (i.e., in the forward direction LD along the axial line CL of the electrode tip 38). A sample exhibiting a deformation ΔH of 0 was evaluated as “A;” a sample exhibiting a deformation ΔH of less than 1 mm was evaluated as “B;” and a sample exhibiting a deformation ΔH of 1 mm or more was evaluated as “C.”

Further, comprehensive evaluation was conducted on the samples. A sample which was evaluated as “C” with respect to even one of the above four evaluation items was evaluated as “C;” a sample which was free of evaluation “C” and was evaluated as “A” with respect to two or more of the four evaluation items was evaluated as “A;” and the remaining samples were evaluated as “B.” According to comprehensive evaluation, samples 1 and 5 having an offset OF of 0 and 0.4 mm were evaluated as “C,” and samples 2, 3, and 4 having an offset OF of 0.1 mm to 0.3 mm were evaluated as “A.”

According to evaluation of appearance of the fusion portion 82, samples 1 and 2 having offsets OF of 0 and 0.1 mm were evaluated as “A;” samples 3 and 4 having an offset OF of 0.2 mm and 0.3 mm were evaluated as “B;” and sample 5 having an offset OF of 0.4 mm was evaluated as “C.” The conceivable reason for the results of the evaluation is as follows. Since as offset OF increases, the distance between the outer side surface 391 of the tip holding element 39 and the outer side surface 381s of the electrode tip 38 on the connection-end direction CD side reduces; as a result, the fusion portion 82 and the electrode tip 38 approach each other. Therefore, the fusion portion 82 is apt to adhere to the electrode tip 38.

According to evaluation of tip joining performance, sample 1 having an offset OF of 0 was evaluated as “C,” and samples 2 to 5 having an offset OF of 0.1 mm to 0.4 mm were evaluated as “A.” The reason for the results of the evaluation is as follows. The connection-end direction CD side of the ground electrode 30 drops in temperature because of heat transfer, whereas the free-end direction FD side of the ground electrode 30 is unlikely to drop in temperature because heat transfer does no occur there. As a result, the free-end direction FD side of the ground electrode 30 is higher in temperature than the connection-end direction CD side of the ground electrode 30. The electrode tip 38 and the tip holding element 39 differ in material and thus differ in thermal expansion coefficient. Specifically, the thermal expansion coefficient of the tip holding element 39 made of a nickel alloy is higher than that of the electrode tip 38 made of a noble metal. Accordingly, if the fusion portion 82 reaches the electrode tip 38 at the first portion PT1 located on the free-end direction FD side having high temperature, a relatively large thermal stress is generated at the first portion PT1. As a result, cracking caused by thermal stress is apt to occur in the fusion portion 82. As a result, lifting or detachment of the electrode tip 38 is apt to occur at the first portion PT1 located on the free-end direction FD side. Accordingly, in sample 1 having an offset OF of 0, since the fusion portion 82 reaches the electrode tip 38 at the first portion PT1 located on the free-end direction FD side having higher temperature, lifting or detachment of the electrode tip 38 is apt to occur. By contrast, in samples 2 to 5 having an offset OF other than 0, since the fusion portion 82 does not reach the electrode tip 38 at the first portion PT1 located on the free-end direction FD side having high temperature, lifting or detachment of the electrode tip 38 is unlikely to occur.

According to evaluation of deformation of the ground electrode 30, similar to the case of evaluation of tip joining performance, sample 1 having an offset OF of 0 was evaluated as “C,” and samples 2 to 5 having an offset OF of 0.1 mm to 0.4 mm were evaluated as “A.” The reason for the results of the evaluation is as follows. As mentioned above, if the fusion portion 82 reaches the electrode tip 38 at the first portion PT1 located on the free-end direction FD side having higher temperature, a relatively large thermal stress is generated. Conceivably, the thermal stress causes deformation of the electrode body 33. Accordingly, in sample 1 having an offset OF of 0, since the fusion portion 82 reaches the electrode tip 38 at the first portion PT1 located on the free-end direction FD side having higher temperature, the electrode body 33 is likely to deform. By contrast, in samples 2 to 5 having an offset OF other than 0, since the fusion portion 82 does not reach the electrode tip 38 at the first portion PT1 located on the free-end direction FD side having high temperature, the electrode body 33 is unlikely to deform.

According to evaluation of thermal conductivity, sample 1 having an offset OF of 0 was evaluated as “B,” and samples 2 to 5 having an offset OF of 0.1 mm to 0.4 mm were evaluated as “A.” The conceivable reason for the results of the evaluation is as follows. If the fusion portion 82 reaches the electrode tip 38 at the second portion PT2 located on the connection-end direction CD side, at the second portion Pt2, the electrode tip 38 and the electrode body 33 are joined via the fusion portion 82. As a result, as compared with the case where the electrode tip 38 and the electrode body 33 are merely in contact with each other, heat transfer from the electrode tip 38 to the electrode body 33 is effectively performed. In sample 1 having an offset OF of 0, the area where the fusion portion 82 reaches the electrode tip 38 is small in the vicinity of the second portion PT2 located on the connection-end direction CD side as compared with samples 2 to 5 having an offset OF other than 0. As a result, conceivably, sample 1 having an offset OF of 0 is inferior in heat transfer (i.e., thermal conductivity) to samples 2 to 5 having an offset OF other than 0.

The above results of examination have revealed the following: in view of tip joining performance, thermal conductivity, and deformation of the ground electrode 30, offset OF is preferably provided such that the fusion portion 82 does not reach the electrode tip 38 at the first portion PT1, whereas the fusion portion 82 reaches the electrode tip 38 at the second portion PT2. In view of appearance of the fusion portion 82, an excessively large offset OF is not preferable. Comprehensively, it has been understood that an offset OF of 0.1 mm to 0.3 mm is preferred.

As is understood from the results of the above evaluation test, even when the fusion portion 82 reaches the electrode tip 38 on the side toward the free end 333 of the ground electrode 30, heat transfer cannot be expected, because a portion of the ground electrode 30 on the free end 333 side is apt to have high temperature and has a free end. Also, in the case where the fusion portion 82 reaches the electrode tip 38 on the side toward the free end 333 of the ground electrode 30, since the portion of the ground electrode 30 on the free end 333 side is apt to have high temperature, the fusion portion 82 is apt to suffer the occurrence of cracking caused by thermal stress stemming from the difference in thermal expansion coefficient between the electrode tip 38 and the tip holding element 39. By contrast, on the side toward the the connection end 332 of the ground electrode 30, when the fusion portion 82 reaches the electrode tip 38, heat transfer is improved. Also, a portion of the ground electrode 30 on the connection end 332 side is unlikely to have high temperature as compared with the portion of the ground electrode 30 on the free end 333 side. Therefore, although the fusion portion 82 reaches the electrode tip 38 on the connection end 332 side, the fusion portion 82 is unlikely to suffer the occurrence of cracking caused by thermal stress. Thus, according to the spark plug 100 of the above embodiment, since length L1 along the axial direction of the fusion portion 82 is longer than length L3 along the axial direction of the recess 335 at the first portion PT1 on the free end 333 side and at the second portion PT2 on the connection end 332 side, the electrode tip 38 can be held with sufficient strength. Further, since the fusion portion 82 does not reach the electrode tip 38 at the first portion PT1, whereas the fusion portion 82 reaches the electrode tip 38 at the second portion PT2, the occurrence of cracking in the fusion portion 82 can be restrained while heat transfer is improved. Therefore, in the course of use in a high-temperature environment, the occurrence of lifting or detachment of the electrode tip can be restrained.

Also, according to the spark plug 100 of the above embodiment, the fusion portion 82 is formed along the entire circumference of the boundary between the outer side surface of the tip holding element 39 and the inner side surface of the recess 335. As a result, in the course of use in a high-temperature environment, the occurrence of lifting or detachment of the electrode tip can be more effectively restrained.

Further, the electrode tip 38 has the tip body 381 and the collar portion 382, and at the second portion PT2, the fusion portion 82 reaches the collar portion 382 of the electrode tip 38. Since the electrode tip 38 has the collar portion 382, the electrode tip 38 can be reliably held to the electrode body 33. Also, at the second portion PT2, the fusion portion 82 can reliably reach the electrode tip. As a result, in the course of use in a high-temperature environment, the occurrence of lifting or detachment of the electrode tip 38 can be more effectively restrained.

Further, according to the spark plug 100 of the above embodiment, the axial line Co of the tip holding element 39 is offset in the free-end direction FD in relation to the axial line CL of the electrode tip 38. As a result, there can be easily implemented the structure in which the fusion portion 82 does not reach the electrode tip at the first portion PT1, whereas the fusion portion 82 reaches the electrode tip at the second portion PT2.

### B. Second Embodiment

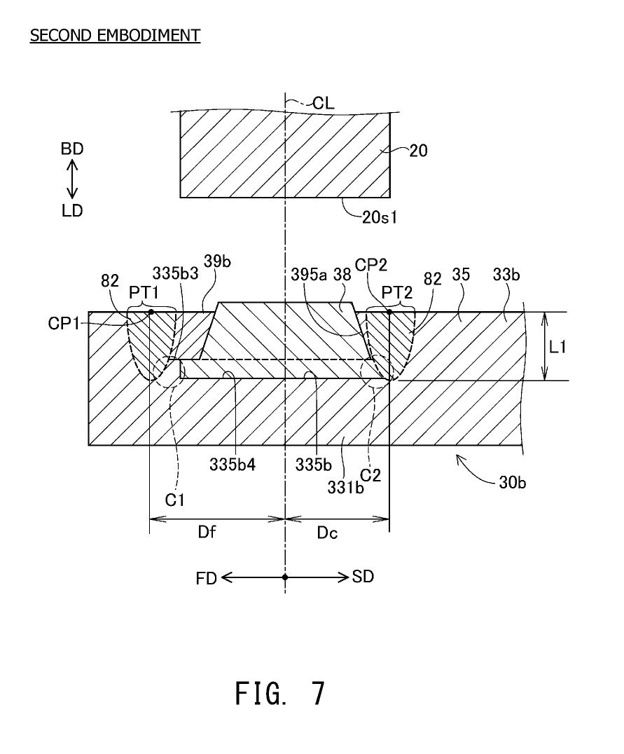

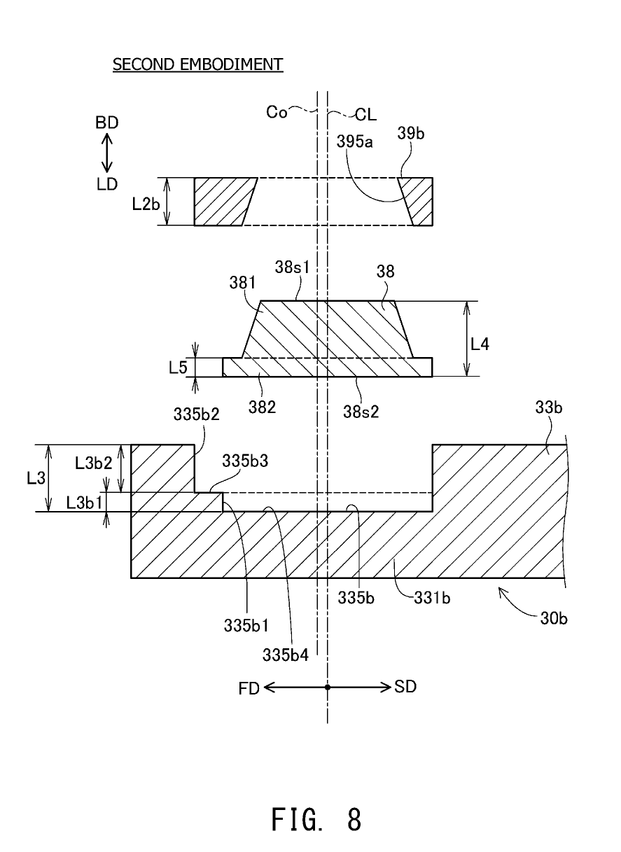

FIG. 7 is a fragmentary sectional view showing, on an enlarged scale, a distal end portion 331b and its periphery of a ground electrode 30b according to a second embodiment. FIG. 8 is an exploded view showing the distal end portion 331b of the ground electrode 30b according to the second embodiment as viewed before laser welding. As shown in FIG. 8, the shape of the tip holding element 39b of the second embodiment differs from the shape of the tip holding element 39 of the first embodiment. Also, the shape of a recess 335b formed in an electrode body 33b of the second embodiment differs from the shape of the recess 335 of the first embodiment. The electrode tip 38 of the second embodiment is the same as the electrode tip 38 of the first embodiment.

As shown in FIG. 8, the tip holding element 39b of the second embodiment has a cylindrical external form. The tip holding element 39b of the second embodiment has the rear-side hole 395a of the tip holding element 39 (FIG. 4) of the first embodiment as a through hole thereof. Further, the tip holding element 39b of the second embodiment does not have the forward-side hole 395b of the tip holding element 39 (FIG. 4) of the first embodiment. Accordingly, length L2b in the axial direction of the tip holding element 39b of the second embodiment is shorter than length L2 in the axial direction of the tip holding element 39 of the first embodiment.

The recess 335b of the second embodiment has an approximately cylindrical forward-side portion 335b1 into which the collar portion 382 of the electrode tip 38 is fitted, and a rear-side portion 335b2 located rearward of the forward-side portion 335b1 and having a diameter greater than that of the forward-side portion 335b1. The rear-side portion 335b2 has an approximately cylindrical shape into which the tip holding element 39b is fitted. The axial line CL of the forward-side portion 335b1 coincides with the axial line CL of the electrode tip 38 and with the axial line CL of the through hole 395a of the tip holding element 39b. The axial line Co of the rear-side portion 335b2 coincides with the axial line Co of the cylindrical external form of the tip holding element 39b. As a result, the axial line Co of the rear-side portion 335b2 is offset in the free-end direction FD in relation to the axial line CL of the forward-side portion 335b1. Length L3b2 in the axial direction of the rear-side portion 335b2 is equal to length L2b in the axial direction of the tip holding element 39b. Length L3b1 in the axial direction of the forward-end portion 335b1 is equal to length L5 in the axial direction of the collar portion 382 of the electrode tip 38.

As shown in FIG. 7, as a result of the tip holding element 39b being laser-welded to the electrode body 33b, the electrode tip 38 is held to the electrode body 33b by the inner surface of the tip holding element 39b which defines the through hole 395a, and by a bottom surface 335b4 of the recess 335b (i.e., the bottom surface of the forward-side portion 335b1). The tip holding element 39b is supported by a step portion 335b3 formed between the forward-side portion 335b1 and the rear-side portion 335b2.

Similar to the first embodiment, distance Df from the center CP1 of the first portion PT1 of the fusion portion 82 located on the free-end direction FD side to the center (i.e., the axial line CL) of the electrode tip 38 is longer than distance Dc from the center CP2 of the second portion PT2 of the fusion portion 82 located on the connection-end direction CD side to the center of the electrode tip 38.

Similar to the first embodiment, length L1 (FIG. 7) in the axial direction of the fusion portion 82 is longer than length L3 (L3b1+L3b2) in the axial direction of the recess 335, along the entire circumference of the fusion portion 82.

Similar to the first embodiment, as indicated by circle C1 in FIG. 7, at the first portion PT1, the fusion portion 82 does not reach the electrode tip 38. Also, as indicated by circle C2 in FIG. 7, at the second portion PT2, the fusion portion 82 reaches the electrode tip 38 (specifically, the collar portion 382 of the electrode tip 38).

In the second embodiment also, similar to the first embodiment, since the fusion portion 82 does not reach the electrode tip 38 at the first portion PT1, whereas the fusion portion 82 reaches the electrode tip 38 at the second portion PT2, the occurrence of cracking in the fusion portion 82 can be restrained while heat transfer is improved. Therefore, in the course of use in a high-temperature environment, the occurrence of lifting or detachment of the electrode tip can be restrained.

### I. Modified Embodiments

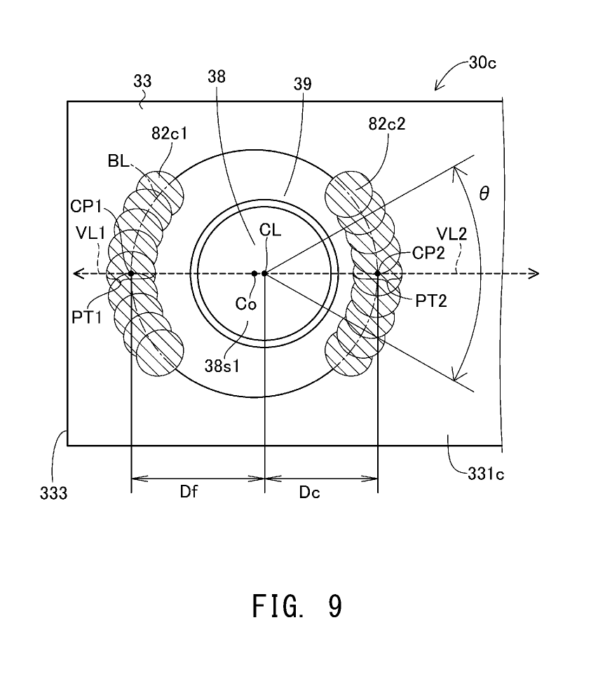

(1) In the first embodiment described above, the fusion portion 82 is formed along the entire circumference of the boundary between the outer side surface of the tip holding element 39 and the inner side surface of the recess 335. However, the present invention is not limited thereto, but the fusion portion may be formed partially at the boundary between the outer side surface of the tip holding element 39 and the inner side surface of the recess 335. FIG. 9 is an explanatory view showing a ground electrode 30c according to a modified embodiment. Similar to FIG. 3, FIG. 9 schematically shows a distal end portion 331c and its periphery of the ground electrode 30c as viewed in the forward direction LD from the rear side.

In the ground electrode 30c of FIG. 9, the fusion portion has a first fusion portion 82c1 located on the free-end direction FD side and a second fusion portion 82c2 located on the connection-end direction CD side. Structural features other than the fusion portion of the ground electrode 30c of FIG. 9 are similar to those of the first embodiment. The first fusion portion 82c1 includes the first portion PT1 which intersects the above-mentioned first line VL1, and the second fusion portion 82c2 includes the second portion PT2 which intersects the above-mentioned second line VL2. In the ground electrode 30c of FIG. 9, as viewed in the direction of the axial line CL of the electrode tip 38, the fusion portion is not formed at portions located in a direction orthogonal to the first line VL1 and to the second line VL2.

In FIG. 9, within a range of a central angle θ of the second fusion portion 82c2 with the second portion PT2 serving as the center of the range, the second fusion portion 82c2 reaches the electrode tip 38. Outside the range of the central angle θ, the second fusion portion 82c2 does not reach the electrode tip 38. The angle θ indicative of the range of the fusion portion which reaches the electrode tip 38 is, for example, preferably less than 160 degrees, more preferably 30 degrees to less than 120 degrees.

(2) The shape of the electrode tip 38 and the shapes of the tip holding elements 39 and 39b are not limited to the shapes of the above-described embodiments, but various other shapes can be employed. For example, the electrode tip may have only the tip body 381 without having the collar portion 382. Also, the electrode tip may have such an external form as to reduce stepwise in size in the rearward direction BD from the forward direction LD side.

The shape of the tip holding element 39 as viewed in the forward direction LD from the rear side may not be circle, but may be other than circle. For example, as viewed in the forward direction LD from the rear side, the tip holding element 39 may have an elliptic shape such that length in the free-end direction FD is longer than length in a direction orthogonal to the free-end direction FD. The tip holding element 39 is formed by use of INCONEL 600, but may be formed by use of other heat resistant materials; for example, a heat resistant nickel alloy different from INCONEL 600.

(3) In the above-described embodiments, the fusion portion extends in a direction orthogonal to the surface 33s of the electrode body 33. That is, in laser welding conducted in the above embodiments, a laser beam is radiated in a direction orthogonal to the surface 33s of the electrode body 33. Instead, the fusion portion may extend obliquely to the surface 33s of the electrode body 33. For example, the fusion portion may be inclined in such a manner as to approach the axial line CL of the electrode tip 38 with distance (i.e., depth) from the surface 33s of the electrode body 33. By contrast, the fusion portion may be inclined in such a manner as to depart from the axial line CL of the electrode tip 38 with distance (i.e., depth) from the surface 33s of the electrode body 33.

(4) The electrode tip 38 of the above-described embodiments is formed of an iridium alloy, but may be formed of a noble metal different from iridium, or an alloy which contains the noble metal as a main component. Employable noble metals different from iridium are, for example, platinum (Pt) and rhodium (Rh).

(5) The structure of the spark plug is not limited to the structure described with reference to FIG. 1, but various structures can be employed. For example, the center electrode 20 may have an electrode tip adapted to form the gap g. An alloy which contains iridium, platinum, or a like noble metal can be employed as material for the electrode tip. The core metal 22 may be eliminated from the center electrode 20.

The present invention has been described with reference to the above embodiments and modified embodiments. However, the embodiments and modified embodiments are meant to help understand the invention, but are not meant to limit the invention. The present invention may be modified or improved without departing from the gist and the scope of the invention and encompasses equivalents of such modifications and improvements.

### DESCRIPTION OF REFERENCE NUMERALS

5: gasket;
6: second packing;
7: third packing;
8: first packing;
9: talc;
10: insulator;
11: second outside-diameter-reducing portion;
12: axial hole;
13: leg portion;
15: first outside-diameter-reducing portion;
16: inside-diameter-reducing portion;
17: first trunk portion;
18: second trunk portion;
19: collar portion;
20: electrode;
20: center electrode;
20s1: forward end surface;
21: electrode base metal;
22: core metal;
23: head portion;
24: collar portion;
25: leg portion;
30, 30b, 30c: ground electrode;
33, 33b: electrode body;
35: base metal;
36: core metal;
38: electrode tip;
38s1: discharge surface;
38s2: opposite surface;
39, 39b: tip holding element;
40: metal terminal member;
41: cap attachment portion;
42: collar portion;
43: leg portion;
50: metallic shell;
51: tool engagement portion;
52: threaded portion;
53: crimp portion;
54: seat portion;
55: trunk portion;
56: inside-diameter-reducing portion;
58: deformed portion;
59: through hole;
60: first seal member;
70: resistor;
80: second seal member;
82: fusion portion;
100: spark plug;
331, 331b, 331c: distal end portion;
332: connection end;
333: free end;
335, 335b: recess;
381: tip body;
382: collar portion

1. A spark plug comprising:
a center electrode;
an electrode tip having a discharge surface forming a gap in cooperation with the center electrode, and an opposite surface located opposite the discharge surface and having a diameter greater than that of the discharge surface;
a tip holding element which has a through hole and in which a portion of the electrode tip is disposed;
a ground electrode body having one end as a connection end connected to a metallic shell and the other end as a free end, and having a recess in which the tip holding element and at least a portion of the electrode tip, the portion including the opposite surface, are disposed; and
a fusion portion formed at at least a portion of a boundary between an outer side surface of the tip holding element and an inner side surface of the recess,
when a direction directed from the opposite surface to the discharge surface is taken as a first direction, a diameter of the through hole at an end oriented in the first direction being equal to or greater than a diameter of the discharge surface and being smaller than a diameter of the opposite surface, and
the electrode tip being held by a bottom surface of the recess and by an inner surface of the tip holding element which defines the through hole,
the spark plug being characterized in that:
when, on a surface facing the first direction of the ground electrode body, an imaginary line extending from an axial line of the electrode tip toward the free end is taken as a first line, whereas an imaginary line extending from the axial line of the electrode tip toward the connection end is taken as a second line,
on the surface of the ground electrode body oriented in the first direction, a distance from a center of a first portion of the fusion portion, which portion intersects the first line, to a center of the electrode tip is longer than a distance from a center of a second portion of the fusion portion, which portion intersects the the second line, to the center of the electrode tip; and
in a section which contains the first line and the axial line of the electrode tip,
a length along the first direction of the fusion portion at the first portion is longer than a length along the first direction of the recess at the first portion,
a length along the first direction of the fusion portion at the second portion is longer than a length along the first direction of the recess at the second portion,
at the first portion, the fusion portion does not reach the electrode tip, and
at the second portion, the fusion portion reaches the electrode tip.

2. The spark plug according to claim 1, wherein the fusion portion is formed along the entire circumference of a boundary between the outer side surface of the tip holding element and the inner side surface of the recess.

3. The spark plug according to claim 1, wherein
the electrode tip has a tip body including the discharge surface, and a collar portion including the opposite surface, having a diameter greater than that of the tip body, and located on a side of the tip body opposite the first direction, and
at the second portion, the fusion portion reaches the collar portion of the electrode tip.

4. The spark plug according to claim 2, wherein
the electrode tip has a tip body including the discharge surface, and a collar portion including the opposite surface, having a diameter greater than that of the tip body, and located on a side of the tip body opposite the first direction, and
at the second portion, the fusion portion reaches the collar portion of the electrode tip.
